(19) United States
(12) Patent Application Publication
(10) Pub. No.: US 2002/0063432 A1
(43) Pub. Date: May 30, 2002

(54) Trunk lid unlocking apparatus for emergency escape

(76) Inventor: Se-Wan Choi, Kyungki-Do (KR)

Correspondence Address: BIRCH STEWART KOLASCH & BIRCH, PO BOX 747, FALLS CHURCH, VA, 22040-0747, US

(21) Appl. No.: 09/973,803

(22) Filed: Oct. 11, 2001

(30) Foreign Application Priority Data
Nov. 30, 2000 (KR) 2000-72185

(51) Int. Cl. E05B 3/00

(52) U.S. Cl. 292/336.3

(57) ABSTRACT

The present invention relates to a trunk lid unlocking apparatus for emergency escape which achieves improvements in job efficiency and product functionality by integrally modularizing all the related parts in the trunk, the apparatus being constructed in the modularized structure with a handle internally installed in the trunk lid, a lever connected to the open handle, a guide member supporting the open cable connected with the lever, a fixing hitch coupled with the guide member, an open lever for unlocking the locking apparatus and pawl lever.

### BACKGROUND OF THE INVENTION

1. Field of the Invention

The present invention relates to a trunk of a vehicle and more particularly to a trunk lid unlocking apparatus for emergency escape with an improvement in functionality and assembly efficiency by structural modularization.

2. Description of the Invention

As shown in FIG. 2, a general emergency trunk lid unlocking apparatus with which a person can manually unlock a vehicle trunk from inside in an event of emergency is constructed with a handle 1 connected with an open cable 3 internally along a trunk lid for manipulating a latch assembly 5 of a locking/unlocking apparatus of a trunk. The open cable 3 is coupled for manipulating a lock lever 6 of a latch assembly 5 connected to the handle 1 and manipulated by a latch 4. At this time, the latch assembly 5 includes a guide member 8 connected for supporting the open cable 3 and a fixing hitch 7 connected for fixing the open cable 3 at the guide member 8. Besides, the open cable 3 has an operating hitch 9 connected with a lock lever 6 for unlocking the locking apparatus, and the latch 4 is mounted onto an internal panel of a latch assembly.

On the other hand, in the procedure of assembling the trunk lid unlocking apparatus, a step of inserting the open cable 3 into the operating hitch 9 is very difficult for a worker, and the open cable 3 is frequently bent. As a result, there is a problem in the conventional trunk unlocking apparatus in that there have been frequently found mechanical and functional faults in completely assembled products and inconveniences in the assembling procedure. In addition, as shown in FIG. 2, the guide member 8 of the open cable 3 has a structure of being inserted into the fixing hitch 7. At this time, since it is a tough job to couple the guide member 8 and the fixing hitch 7, it requires a lot of efforts and time and can be a cause for deteriorating the job efficiency.

### SUMMARY OF THE INVENTION

It is an object of the present invention to solve the aforementioned problems and provide a vehicle trunk unlocking apparatus for emergency escape which achieves an improvement in job efficiency of assembling procedures and functionality in products by integrally modularizing all the related parts.

In order to accomplish the aforementioned object of the present invention, there is provided a trunk lid unlocking apparatus for unlocking the trunk lid of a vehicle from inside, the apparatus comprising:

a lever installed at an internal side of a trunk lid for unlocking a latch assembly;

an open cable for being pulled by pivoting manipulation of the lever;

an open lever installed for pivoting around a hinge with an end portion of the open cable attached to a connection member; and

a pawl lever pushed to the open direction along with pivoting of the open lever for unlocking the latch assembly.

### BRIEF DESCRIPTION OF THE DRAWINGS

For fuller understanding of the nature and object of the invention, reference should be made to the following detailed description taken in conjunction with the accompanying drawings in which:

FIG. 1 is a perspective view for illustrating a vehicle trunk with a general trunk lid unlocking apparatus;

FIG. 2 is a view for illustrating a structure of a trunk lid unlocking apparatus according to the prior art;

FIG. 3 is a view for illustrating a structure of a trunk lid unlocking apparatus according to the present invention;

FIG. 4 is a view for illustrating an operational structure of a trunk lid unlocking apparatus according to the present invention;

FIG. 5 is a view for illustrating an opened structure of a trunk lid unlocking apparatus according to the present invention.

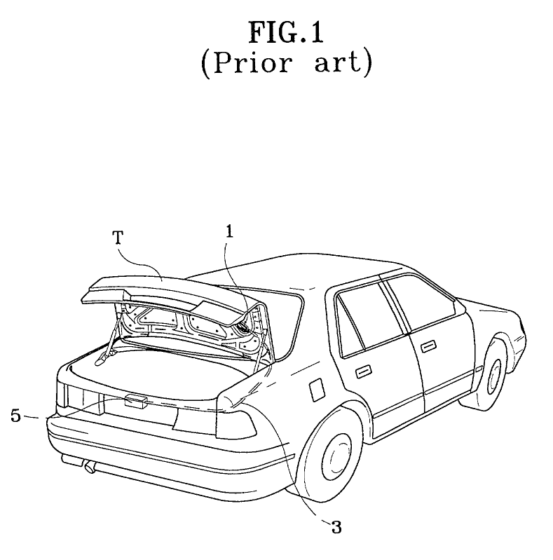

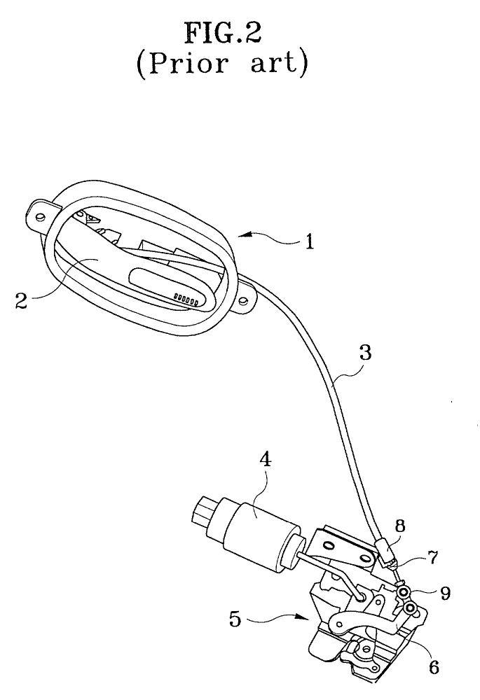

### DETAILED DESCRIPTION OF THE INVENTION

Hereinafter, a preferred embodiment of the present invention will be described in detail with reference to accompanying drawings.

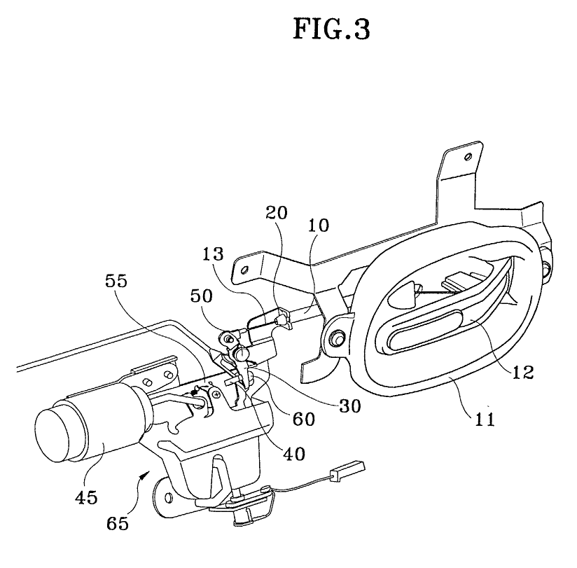

As shown in FIG. 3, a trunk lid unlocking apparatus to unlock a trunk lid from the inside of the vehicle trunk is constructed with a handle 11 installed at the internal side of the trunk lid to unlock a latch assembly 70 as a trunk lid locking apparatus, a lever 12 rotationally attached to the handle 11, an open cable 13 connected to the lever 12 to be pulled by pivoting manipulation of the lever 12, a pipe-shaped guide member 10 surrounding an external side of the open cable 13 to allow for the sliding movement of the open cable 13 and a fixing hitch 20 fixedly supporting the guide member 10 for a reciprocal movement with the open cable 13.

The fixing hitch 20 is integrally connected with an internal panel 55 of a latch assembly, and the end part of the open cable 13 is connected with a connecting member 15 that supports the open cable. The connecting member 15 is a perpendicularly bent, pipe-shaped member for connecting the open cable 13 to an open lever 30.

The connecting member 15 is connected with a fixing member 16. The fixing member 16 is coupled with the open lever 30 pivoting around a hinge 50. A pawl lever 40 is positioned at one side of the open lever 30 for being pushed along with rotation of the open lever 30 to an open direction to unlock the latch assembly 70 as a trunk lid locking apparatus. The pawl lever 40 is connected to the latch assembly 70 with a hinge pin 60.

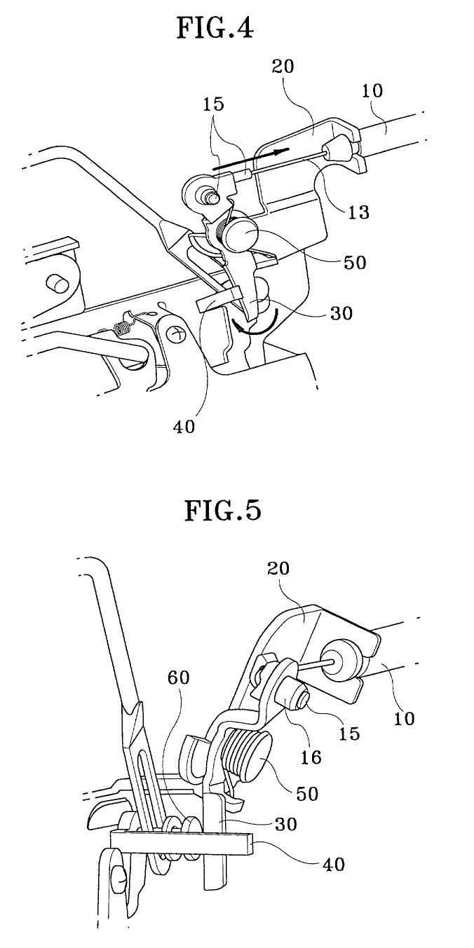

FIG. 4 illustrates an operational state of a trunk lid unlocking apparatus in accordance with the present invention. If the lever 12 of the trunk locking apparatus is pulled to an arrow direction, the open cable 13 connected with the lever 12 is pulled to rotate the open lever 30 around the hinge 50 to a direction opposite to the operation of the open cable 13.

FIG. 5 illustrates the operational state of the trunk lid unlocking apparatus where the open lever 30 operated by the open cable 13 is rotated around the hinge 50 and pushes the pawl lever 40 to the rear to unlock the trunk lid locking apparatus.

In other words, the trunk lid unlocking apparatus has the fixing hitch 20 integrally formed at the latch assembly panel 55 to support the guide member 10 which guides the open cable 13 and is constructed in the modularized structure with unlocking pawl lever 40, hinge 50, fixing member 16 and connecting member 15 for releasing the locked state.

As described above, the trunk unlocking apparatus for emergency escape of the present invention has advantages by making improvements for the fixing hitch, which simultaneously connects the open cable and the latch of the locking apparatus and makes the locking operation possible, and for the open lever, the operating hitch, which makes operations possible in the reverse direction and in that parts conventionally causing job inefficiency are modularized for an improvement in job efficiency.

Therefore, the trunk lid unlocking apparatus of the present invention has advantages in improvements in function and assembly of products, low cost from reduction in the number of parts and operational steps and an increased conveniences in assembling steps.

What is claimed is:

1. A trunk lid unlocking apparatus for emergency escape, the apparatus comprising:
a lever installed at an internal side of a trunk lid for unlocking a latch assembly;
an open cable for being pulled by pivoting manipulation of the lever;
an open lever installed for pivoting around a hinge with an end portion of the open cable attached to a connection member; and
a pawl lever pushed to the open direction along with pivoting of the open lever for unlocking the latch assembly.

2. The apparatus, as defined in claim 1, wherein a pipe-shaped guide member is surrounded at the external side of the open cable for the sliding movement and a fixing hitch is mounted at the latch assembly that fixedly supports the guide member.

3. The apparatus, as defined in claim 1, wherein a pawl lever sequentially moving along with pivoting of the open lever is positioned at an internal panel of the latch assembly with a hinge pin.
